(19) United States
(12) Patent Application Publication
(10) Pub. No.: US 2007/0169651 A1
(43) Pub. Date: Jul. 26, 2007

(54) Printing machine

(75) Inventors: Jurgen Michels, Dossenheim (DE); Dieter Schaffrath, Lorsch (DE); Wolfgang Schonberger, Schriesheim (DE); Bernhard Schwaab, Neustadt (DE); Michael Thielemann, Heidelberg (DE)

Correspondence Address: LERNER GREENBERG STEMER LLP, P O BOX 2480, HOLLYWOOD, FL, 33022-2480, US

(73) Assignee: Heidelberger Druckmaschinen AG

(21) Appl. No.: 11/649,085

(22) Filed: Jan. 3, 2007

Related U.S. Application Data
(60) Provisional application No. 60/759,632, filed on Jan. 17, 2006.

(30) Foreign Application Priority Data
Jan. 17, 2006 (DE) 10 2006 002 170.3

(51) Int. Cl. B41F 31/00

(52) U.S. Cl. 101/350.5

(57) ABSTRACT

A printing machine includes an inking unit having a roller and a doctor-type ink fountain associated with the roller. The doctor-type ink fountain has an adjustable rear wall for setting an ink level of printing ink stored in the doctor-type ink fountain. The rear wall has a flow profile for flow-mechanically influencing the printing ink.

### CROSS-REFERENCE TO RELATED APPLICATION

This application claims the priority, under 35 U.S.C. §119(e), of Provisional Patent Application No. 60/759,632, filed Jan. 17, 2006. This application also claims the priority, under 35 U.S.C. §119, of German Patent Application DE 10 2006 002 170.3, filed Jan. 17, 2006. The prior applications are herewith incorporated by reference in their entirety.

### BACKGROUND OF THE INVENTION

### Field of the Invention

The present invention relates to a printing machine including an inking unit having a roller and a doctor-type ink fountain associated with the roller. The doctor-type ink fountain has an adjustable rear wall for setting an ink level of printing ink stored in the doctor-type ink fountain.

Such a printing machine is described in U.S. Pat. No. 6,705,223 B2. In that prior art printing machine, the roller is an engraved roller and the printing ink is transferred out of the doctor-type ink fountain on to the engraved roller, i.e. the filling of the cells of the engraved roller with the printing ink is not adequately uniform under certain circumstances. The cell filling can depend on the printing speed and can be impaired by disruptive turbulence of the printing ink stored in the doctor-type ink fountain and by air bubbles forming in the printing ink.

### SUMMARY OF THE INVENTION

It is accordingly an object of the invention to provide a printing machine which overcomes the hereinafore-mentioned disadvantages of the heretofore-known devices of this general type and in which more uniform transfer of printing ink from a doctor-type ink fountain to a roller is ensured.

With the foregoing and other objects in view there is provided, in accordance with the invention, a printing machine. The printing machine comprises an inking unit including a roller and a doctor-type ink fountain associated with the roller. The doctor-type ink fountain has an adjustable rear wall for setting an ink level of printing ink stored in the doctor-type ink fountain. The rear wall has a flow profile for flow-mechanically influencing the printing ink.

In the case of a multi-part construction, the flow profile can be fixed to the rear wall and, in the case of a one-piece construction, it can be integrally molded onto the rear wall.

In connection with the present invention, printing ink is also understood to mean varnish and the inking unit is also understood to include a varnishing unit.

One advantage of the flow profile is to be seen in the fact that, through the use of the latter, the uniformity of the transfer of the printing ink from the doctor-type ink fountain to the roller is improved. The uniformity is no longer dependent to such a great extent on the printing speed. Turbulence and air bubbles in the printing ink, which impair the uniformity, are reduced to a sufficient extent. If the roller is constructed as an engraved roller with an engraved structure, for example being formed of cells, the filling of the engraved structure with the printing ink, which is known as cell filling, is made more uniform and improved by the flow-mechanical effect of the flow profile.

An additional advantage is to be seen in the fact that the flow-mechanical effect of the flow profile on the printing ink can take place without a disruptive secondary effect on the doctor and a fountain base of the doctor-type ink fountain. The printing ink that is backed up in front of the flow profile because of static pressure as a result of hydrodynamic forces exerted on the flow profile by the printing ink are dissipated over the rear wall by the flow profile. Due to the jointed connection of the rear wall to the fountain base, i.e. through a thrust joint or preferably a rotary joint, the hydrodynamic forces absorbed by the rear wall are not transmitted to the fountain base and to the doctor fixed thereto.

An additional advantage is to be seen in the fact that, when the rear wall is adjusted away from the roller, the flow profile is very easily accessible and therefore can be cleaned conveniently during a printing ink change.

In accordance with another feature of the invention, the rear wall is mounted in such a way that it can be adjusted as desired into a first position, in which or as a result of which the ink level lies above a doctor blade of a doctor of the doctor-type ink fountain, and into a second position, in which or as a result of which the ink level lies below the doctor blade of the doctor of the doctor-type ink fountain. The doctor blade forms the highest point of the doctor.

In accordance with a further feature of the invention, the rear wall is mounted in such a way that it can be pivoted about a rotary joint into the first position and into the second position. The rotary joint is disposed above a fountain base of the doctor-type ink fountain.

In accordance with an added feature of the invention, the flow profile and the circumferential surface of the roller together form a bottleneck, which is located above the doctor blade when the rear wall is in the first position.

In accordance with an additional feature of the invention, the flow profile has an outer corner determining the bottleneck. The outer corner has an angle which is greater than 45° and less than 135°. In particular, this angle can be greater than 60° and less than 120°. The angle of the outer corner is preferably approximately 90°, that is to say the outer corner is approximately rectangular.

In accordance with yet another feature of the invention, the flow profile has an inner corner. The inner corner can have an angle which is at least 90°. This angle can be approximately 135°.

In accordance with yet a further feature of the invention, there is at least one element for securing a contact existing between the rear wall and a film. The film is inserted into the doctor-type ink fountain in such a way that the film covers at least the fountain base.

In accordance with yet an added feature of the invention, the element is a cushion which is disposed between the film and the fountain base of the doctor-type ink fountain. The cushion can be a solid material cushion, for example a plastic cushion. In this case, the cushion can be foamed. The film and the cushion can be produced in one piece from a composite material. Instead, the film and the cushion can also be fabricated in two parts, with the film lying on the cushion in the doctor-type ink fountain.

In accordance with yet an additional feature of the invention, the film is formed as a disposable article which can be disposed of regularly when cleaning the doctor-type ink fountain. In the event of a color change, the printing ink used for the preceding print job is removed from the doctor-type ink fountain and, subsequently, the film together with the ink residue remaining are removed from the doctor-type ink fountain and thrown away. Following the insertion of an unused, new film into the doctor-type ink fountain, the printing ink required for the following print job is put into the doctor-type ink fountain.

In accordance with again another feature of the invention, the rear wall has a metallically hard sliding surface, with which the rear wall rests on the film in order to produce the contact.

In accordance with again a further feature of the invention, the film and the rear wall together delimit an offset printing ink supply formed by the printing ink, which is stored in the doctor-type ink fountain. The printing ink stored in the doctor-type ink fountain is therefore preferably highly viscous.

In accordance with again an added feature of the invention, a surface of the fountain base facing the film is curved concavely.

In accordance with a concomitant feature of the invention, the inking unit is an anilox inking unit and the roller is an engraved roller.

Other features which are considered as characteristic for the invention are set forth in the appended claims.

Although the invention is illustrated and described herein as embodied in a printing machine, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1A is a partly sectional, side-elevational view of a doctor-type ink fountain which has an adjustable rear wall with a flow profile that has been adjusted into a maintenance position withdrawn from a roller;

FIG. 1B is a view similar to FIG. 1, showing the adjustable rear wall having the flow profile in an operating position in the vicinity of the roller; and

FIG. 2 is a rear-perspective view of the doctor-type ink fountain.

### DESCRIPTION OF THE PREFERRED EMBODIMENTS

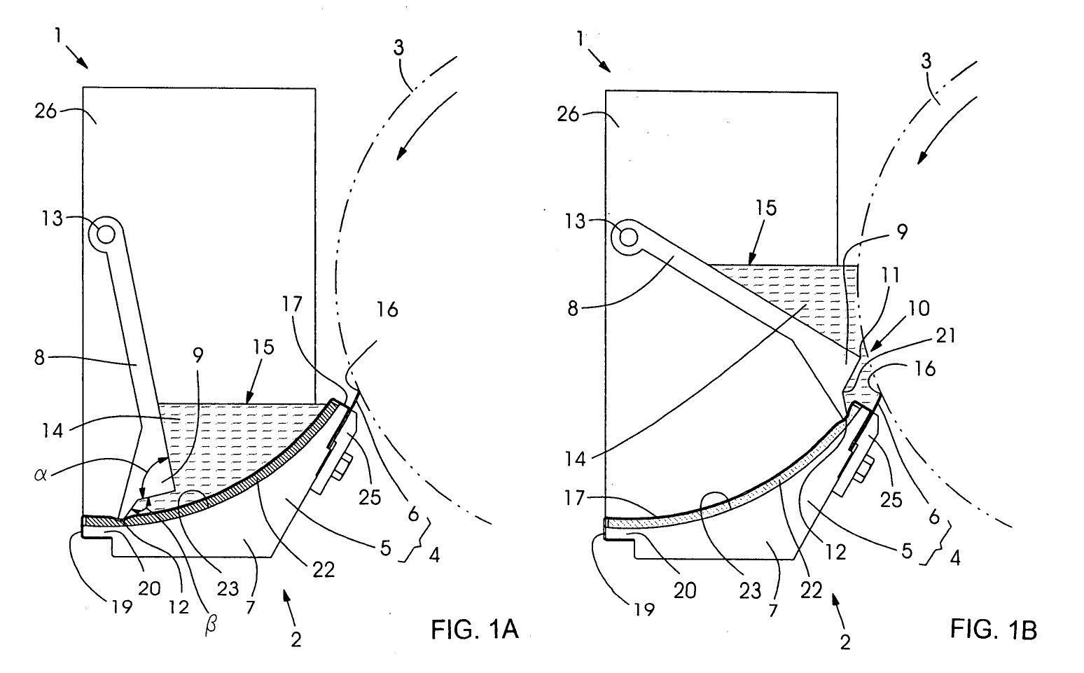

Referring now to the figures of the drawings in detail and first, particularly, to FIG. 1A thereof, there is seen a printing machine 1 which includes an anilox inking unit 2 having an engraved roller 3 and a doctor-type ink fountain 4, which has an ink fountain 5 and a doctor 6. The doctor 6 is fixed to the ink fountain 5 through the use of a clamping device 25 constructed as a quick-action catch.

The ink fountain 5 includes a rear wall 8, which is fixed to a side wall 26 of the ink fountain 5 through the use of a rotary joint 13. A tray-like fountain base 7 of the ink fountain 5 has an area 23 which is curved in the form of a circular arc and has a center of curvature which is the rotary joint 13. A highest point of the doctor 6 is formed by a doctor blade 16 thereof which, during printing operation, bears on the engraved roller 3.

The interior of the ink fountain 5 is lined with a film 17 which is formed of a plastic, for example polythene (PE) or polyethylene terephthalate (PET). The film 17 can have a surface which repels printing ink, is oleophobic and therefore anti-adhesive. Ends of the film 17 are angled-over substantially in a U shape. A hook-like part of a front end of the film 17, together with the doctor 6, form a pack or package which is clamped in the clamping device 25. A rear end of the film 17 likewise forms a hook 19 which, in order to secure it, is hooked into a projection 20 disposed on the ink fountain 5.

The rear wall 8, the film 17, the side wall 26 and an opposite side wall 26 of the ink fountain 5 together delimit an offset printing ink supply 14, which is stored in the doctor-type ink fountain 4. Of course, instead of the offset printing ink supply 14, it is also possible to store a supply of other printing ink, which has a similarly high viscosity, as the offset printing ink.

An ink level 15, formed by the offset printing ink supply 14, is raised by pivoting of the rear wall 8 toward the doctor 16, around the rotary joint 13, to such an extent that this ink level 15 is above the doctor blade 16. This raising of the ink level 15 is carried out after the doctor 6 has been set on the engraved roller 3 at a negative angle of attack for the printing operation. A first position, in which the rear wall 8 is kept during the printing operation, is illustrated in FIG. 1B. In this first position, so to speak, a holding volume of the doctor-type ink fountain 4 is reduced as compared with a second position of the rear wall 8 (compare FIG. 1A), so that the offset printing ink supply 14 would run over the doctor 6 and out of the doctor-type ink fountain 4 if the latter were not set against the engraved roller 3. In order to be able to set the doctor-type ink fountain 4 off the engraved roller 3, for example for the purpose of changing the offset printing ink supply 14, the ink level 15 is lowered, by pivoting the rear wall 8 away from the doctor 6, to such an extent that, when the rear wall 8 is in the second position, the ink level 15 is below the doctor blade 16. Following this lowering of the ink level 15, the offset printing ink supply 14 can no longer run out of the doctor-type ink fountain 4 when the latter is set off the engraved roller 3.

The rear wall 8 has a sliding surface 12 at its free end, which slides on the film 17 as the rear wall 8 is pivoted. The sliding surface 12 is composed of the same metal, for example steel or preferably aluminum, from which the whole of the rest of the rear wall is produced. An elastic or springy element 22 is provided in order to ensure a permanent and elastic contact between the rear wall 8 and the film 17 and in order to avoid printing ink penetrating through between the rear wall 8 and the film 17.

The element 22 is a solid material cushion, which is composed of a plastic foam, for example polyethylene terephthalate foam (PET foam) or ethylene/propylene/diene rubber foam (EPDM foam) and which, as an underlay for the film 17, is disposed between the latter and the concave surface 23 of the fountain base 7. The solid material cushion 22 and the film 17 can be inserted into the doctor-type ink fountain 4 one after the other or, instead, can be joined together in a sandwich structure and inserted into the doctor-type ink fountain 4 in one piece.

The solid material cushion 22 is compressible in such a way that, both in the first position and in the second position as well as in every intermediate position of the rear wall 8 between these two positions, it presses the film 17 against the rear wall 8. The prestressing action exerted by the solid material cushion 22 can be seen in FIGS. 1A and 1B by using the small reversible deformation of the film 17 and of the solid material cushion 22 in the region of the sliding surface 12. The sliding surface 12 is forced a little into the solid material cushion 22, so that the latter and the film 17 lying above it in the region of the sliding surface 12 form a hollow which is small and reversible when the load is relieved.

FIGS. 1A and 1B show that the rear wall 8 has a flow profile 9 which faces the engraved roller 3 and which is disposed at the lower end of the rear wall 8, opposite the rotary joint 13. The flow profile or profiled part 9 has an outer corner 11 which forms an angle running at right angles relative to the plane of FIGS. 1A and 1B. This edge can be provided with a small rounded portion or chamfer. An angle a of the outer corner 11 is approximately a right angle. In addition, the flow profile 9 has an inner corner 21 with an angle P which is obtuse. The outer corner 11 is located between the rotary joint 13 and the inner corner 21. The inner corner 21 is located between the outer corner 11 and the sliding surface 12.

When the rear wall 8 is adjusted towards the engraved roller 3 for the printing operation (see FIG. 1B), the outer corner 11 is the region of the flow profile 9 that is closest to the engraved roller 3. In this case, the flow profile 9 and its outer corner 11 do not bear on the engraved roller 3 but are very close to the latter. The outer corner 11, together with the circumferential surface of the engraved roller 3, thus forms a bottleneck 10. In the region of the inner corner 21, the rear wall 8 forms a printing ink antechamber for a printing ink supply, which is located underneath the outer corner 11. Above the outer corner 11 there is a printing ink main chamber for a printing ink supply, having a storage volume which is greater than that of the printing ink antechamber.

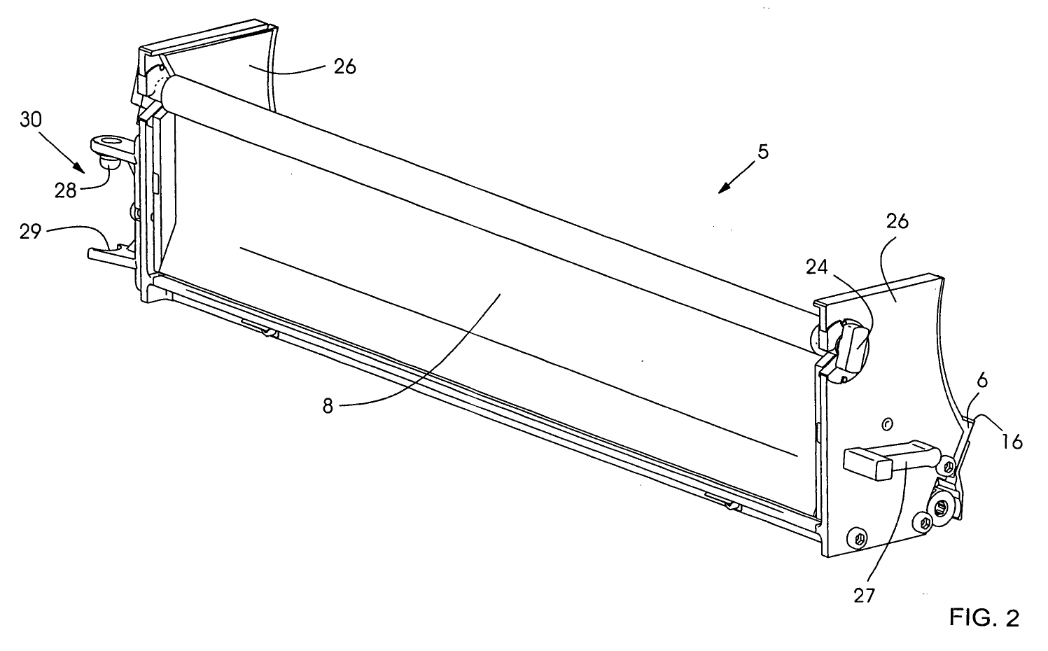

FIG. 2 shows that a positioning pin 27 is fitted to one side wall 26 and is used to align the doctor-type ink fountain 4 relative to the engraved roller 3. The positioning pin 27 has a substantially bone-shaped profile. A hinged pin 28 projecting downward and a joint cup 29 in the form of a half-shell, are disposed on the other side wall 26. The joint pin 28 engages in a joint hole in a machine side frame or a component fitted thereto. For reasons of improved clarity, the machine side frame and the component fitted thereto are not illustrated in the drawing. The joint cup 29 is supported on a joint pin, which is likewise not illustrated in the drawing and is fixed to the machine side frame, so that the four components form a rotary joint 30 having a vertical geometric axis of rotation.

For maintenance purposes, the entire doctor-type fountain 4 can be pivoted about the rotary joint 30, that is to say in the horizontal plane, and away from the engraved roller 4. The joint pin 28 and the joint cup 29 permit the ink fountain 4 to be removed from the printing machine 1 without any tools. For the purpose of this removal, the doctor-type ink fountain 4 is raised upward until the joint pin 28 has been pulled out of the joint hole. In other words, the rotary joint 30 permits the doctor-type ink fountain 4 to be unhooked and hooked-in during its removal from the printing machine 1, carried out for maintenance purposes, and the subsequent reinsertion of the doctor-type ink fountain 4.

A coupling 24, through which the rear wall 8 is provided with a drive connection to an actuating drive, is disposed on the side of the doctor-type ink fountain 4 opposite the rotary joint 30. The actuating drive is not illustrated in the drawing and can be a pneumatic operating cylinder or an electric motor which includes a front-mounted screw gearbox having a threaded spindle. The actuating drive likewise has a drive connection to the rear wall 8 through a lever, likewise not illustrated in the drawing, when a half coupling disposed on the lever is in engagement with a half of the coupling 24 disposed on the rear wall 8 and illustrated in the drawing. The coupling 24 including the two half couplings is a claw coupling and is disposed coaxially with the rotary joint 13. In the event that the actuating drive is constructed as an operating cylinder, its piston rod is attached to the aforementioned lever and, in the event of the actuating drive being constructed as an electric motor, is attached to its front-mounted screw gearbox. The pivoting movement of the lever driven by the actuating drive is transmitted through the coupling 24 to the rear wall 26, in order to adjust the latter as desired into the first position (see FIG. 1B) and into the second position (see FIG. 1A).

The flow profile 9 causes a back pressure of the printing ink in the region of the bottleneck 10 when the printing ink is conveyed toward the bottleneck by the rotation of the engraved roller 3. Due to this back pressure, engraved depressions (cells or grooves) of the engraved roller 3 are filled largely without air inclusions and very uniformly.

A force acts on the rear wall 8 as a consequence of the aforementioned back pressure. This force attempts to force the rear wall 8 away from the engraved roller 3 and, in the process, to rotate it about the rotary joint 13 in the clockwise direction with respect to FIG. 1B. This force flows away from the rear wall 8 through the coupling 24 and the aforementioned lever onto the actuating drive, which absorbs the force. Due to the movable connection (rotary joint 13) of the rear wall 8 to the side walls 26, the force cannot be absorbed by the latter, cannot be transmitted by the latter to the fountain base 7 fixed to the side walls 26 and cannot be transmitted from the fountain base 7 to the doctor 6 fixed to the fountain base 7 through the use of the clamping device 25, so that deflections and deformations of the fountain base 7 resulting from the force flow, of the clamping device 25 and above all of the doctor 26, are avoided reliably and the latter bears uniformly on the engraved roller 3 over the entire printing width.

We claim:

1. A printing machine, comprising:
an inking unit including a roller and a doctor-type ink fountain associated with said roller;
said doctor-type ink fountain having an adjustable rear wall for setting an ink level of printing ink stored in said doctor-type ink fountain; and
said rear wall having a flow profile for flow-mechanically influencing the printing ink.

2. The printing machine according to claim 1, wherein:
said doctor-type ink fountain has a doctor with a doctor blade; and
said rear wall is mounted for adjustment as desired into a first position, in which said ink level lies above said doctor blade, and into a second position, in which said ink level lies below said doctor blade.

3. The printing machine according to claim 2, wherein:
said doctor-type ink fountain has a fountain base; and
said rear wall is mounted for pivoting about a rotary joint into said first position and into said second position, and said rotary joint is disposed above said fountain base.

4. The printing machine according to claim 2, wherein said flow profile and said roller together form a bottleneck located above said doctor blade when said rear wall is in said first position.

5. The printing machine according to claim 4, wherein said flow profile has an outer corner determining said bottleneck, and said outer corner has an angle greater than 45° and less than 135°.

6. The printing machine according to claim 5, wherein said angle of said outer corner is approximately 90°.

7. The printing machine according to claim 1, wherein said flow profile has an inner corner.

8. The printing machine according to claim 7, wherein said inner corner has an angle of at least 90°.

9. The printing machine according to claim 1, which further comprises a film, and at least one element for securing a contact existing between said rear wall and said film.

10. The printing machine according to claim 9, wherein said doctor-type ink fountain has a fountain base, and said element is a cushion disposed between said film and said fountain base.

11. The printing machine according to claim 10, wherein said film is a disposable article to be disposed of regularly when cleaning said doctor-type ink fountain.

12. The printing machine according to claim 9, wherein said rear wall has a metallically hard sliding surface, with which said rear wall rests on said film to produce said contact.

13. The printing machine according to claim 9, wherein the printing ink forms offset printing ink supplies stored in said doctor-type ink fountain, and said film and said rear wall delimit one of the offset printing ink supplies.

14. The printing machine according to claim 10, wherein said fountain base has a concavely curved surface facing said film.

15. The printing machine according to claim 1, wherein said inking unit is an anilox inking unit and said roller is an engraved roller.
